(19) United States
(12) Patent Application Publication
(10) Pub. No.: US 2011/0249467 A1
(43) Pub. Date: Oct. 13, 2011

(54) LIGHT EMITTING DEVICE CREATING DECORATIVE LIGHT EFFECTS IN A LUMINAIRE

(75) Inventor: Erik Boonekamp, Utrecht (NL)

(73) Assignee: KONINKLIJKE PHILIPS ELECTRONICS N.V., EINDHOVEN (NL)

(21) Appl. No.: 13/139,646

(22) PCT Filed: Dec. 11, 2009
(86) PCT No.: PCT/IB2009/055679

§ 371 Date: Jun. 14, 2011

(30) Foreign Application Priority Data
Dec. 18, 2008 (EP) 08172147.4

(51) Int. Cl. F21V 8/00

(52) U.S. Cl. 362/555

(57) ABSTRACT

The present invention relates to a light emitting device (100) comprising a side emitting light source (102) and a light guide plate (101) having at least one light input area (101a) and at least one light output area (101b). Such a device (100) may be used for replacing an incandescent light source or arranged to create various decorative light sparkling effects.

A wide light intensity distribution matching that of an incandescent light source may be achieved.

### FIELD OF THE INVENTION

The present invention relates to a light emitting device comprising a side emitting light source and a light guide plate having at least one light input area and at least one light output area; the light guide plate being arranged to extend in a direction generally transverse to the longitudinal axis of the light guide plate.

### BACKGROUND OF THE INVENTION

For many applications it is desired to create an appealing and pleasing lighting environment, e.g. in a professional or a home setting. For example, chandeliers exhibit light effects, which are considered to be highly decorative.

Chandeliers and other types of luminaires typically utilize conventional incandescent light sources to achieve a pleasant and decorative lighting.

Incandescent light sources typically convert an electrical current to light by applying a current to a filament, which causes the filament to glow. The filament is generally suspended near the center of a glass bulb, thereby providing radial distribution of light that can be used to illuminate e.g. a room.

Such radial distribution of light is desired, but incandescent light sources suffer from disadvantages such as short life span and potential danger of burning objects that come into contact with the glass bulb. The glass bulb generally becomes very hot due to the high temperature of the filament.

Replacing incandescent light sources with LED light sources may alleviate or eliminate the above mentioned problems and provide a significant increase in efficacy.

However, most LEDs are only capable of emitting light into a hemisphere (solid angle 2π sr), whereas incandescent light sources employing a glowing filament generally emit light uniformly into a full sphere (solid angle 4π sr).

The emission of light in a full circle is described in US 2006/0076568 A1, which relates to light emitting diode packages and lenses for directing and emitting light at the side of an LED.

A typical aspect of the device in US 2006/0076568 is a rather narrow light intensity profile allowing for incoupling of light in thin light guide plates

For replacing a clear incandescent light source there is however a need for a light emitting device which can yield a wide light intensity distribution.

There is also a need for a device which may be adjusted to create various optical (and decorative) effects in a professional or home setting; e.g. in some instances it is desired to achive a smooth and homogenous light intensity output, whereas in others it may be desired to create a “sparkling light effect”.

Such a device should be compact, efficient and inexpensive to manufacture.

### SUMMARY OF THE INVENTION

One object of the present invention is to fulfil the above mentioned need and to provide a light emitting device which provides for a pleasant and decorative lighting environment and which overcomes the drawbacks described above.

This and other objects of the present invention are achieved by a light-emitting device according to the appended claims.

Thus, in a first aspect the present invention relates to a light emitting device comprising:

at least one side emitting light source comprising at least one light emitting diode and a reflective layer arranged spaced apart from the light emitting diode(s), and

a light guide plate which has at least one light input area and at least one light output area. The light guide plate extends in a direction generally transverse to the longitudinal axis of the light guide.

The light guide plate comprises a depression, wherein the side emitting light source is arranged, and this depression forms the light input area.

Light emitted by the LED(s) is incident on the reflective layer of the light source, and, independent on the angle of incidence, it will be reflected. Light exits the light source in a direction generally transverse to the longitudinal axis of the LED(s); i.e. through the opening between the LED(s) and the reflective layer.

The emitted light is received by the at least one light input area of the light guide plate.

Accordingly, light emitted by the light source enters the light guide plate through the light input area, and propagates through the plate by the principle of total internal reflection (TIR). Light is then extracted from the at least one light output area of the light guide plate.

The light guide plate is used both to mix and guide the light from the light source, but also to shape the extracted light intensity distribution.

Since no additional optics, such as lenses are required, a device of the present invention is compact and inexpensive to manufacture.

In a device of the present invention, light is extracted from the light output area with a wide intensity distribution which is almost constant for all viewing angles. The intensity distribution around the device is substantially similar to the light intensity distribution around an incandescent light source.

Accordingly, a device of the invention may be arranged for retrofitting into a luminaire employing an incandescent light source.

In embodiments, the light source may further comprise at least one wavelength converting material arranged between the light emitting diode(s) and the reflective layer.

Hence, light is subject to wavelength conversion before exiting the light source. Accordingly, the colour of the light output may be tailored to the need of the user, without increasing the size of the device or adding external elements to the device. The adjustment and variation of the colour of the light output may be regarded as highly decorative in a professional or home setting.

The wavelength converting material may also have a scattering effect on the light such that light is redistributed, thereby increasing the light output from the lateral edges of the light source.

In embodiments of the invention, the light guide plate is circular. In these embodiments, the light output area extends along the entire circular plate such that light is extracted in a full circle of directions.

Accordingly, the light emitted has a spatial intensity distribution around the device that is substantially similar to the light intensity distribution around an incandescent light source. Thus, the device of the present invention may advantageously be used for replacing an incandescent light source or for fitting into a light fixture normally used for incandescent light sources, such as a filamented light bulb, a halogen lamp, etc.

In order to obtain a smooth light intensity pattern, the depression is typically located in the center of the light guide plate.

In preferred embodiments, the depression has a shape which essentially matches that of the at least one light source.

This allows for an optimal light incoupling efficiency into the light guide plate. Light is efficiently entered in the plate through the light input area, and the light output from the device is further increased.

By varying the shape and dimensions of the depression, various decorative lighting effects may be created. For example, in some instances it may be desired to create a smooth and homogenous light intensity output, whereas in others, a sparkling light effect may be desired.

In alternative embodiments, the thickness of the light guide plate is tapered towards the light input area; i.e. the light guide plate is thinner near the light input area and thicker near the light output area. This creates an extra degree of freedom to shape the light intensity profile.

In order to further increase the incoupling of light into the light guide plate, the depression (which forms the light input area) may be a through hole in the light guide plate.

In alternative embodiments, the light emitting device further comprises a heat sink arranged to transport heat away from the light source. Thus, the light emitting device of the present invention may be kept relatively cool to avoid burns to a user caused by contact. Furthermore, the lifetime of the light source can be increased due to lessened thermal stress and/or strain in the light source components.

In order to increase the scattering of the light extracted from the device, the light output area may comprise microstructures.

In a second aspect, the present invention relates to a luminaire employing a light emitting device as described hereinbefore.

Other objectives, features and advantages of the present invention will appear from the following detailed disclosure, from the attached claims as well as from the drawings.

### BRIEF DESCRIPTION OF THE DRAWINGS

FIG. 1 is a cross sectional view of a light emitting device according to the present invention.

FIG. 2 is a lamp comprising a light emitting device according to the present invention.

FIG. 3 illustrates an exemplary light intensity profile of the far-field angular light intensity distribution of light emitted from a light source according to an exemplary embodiment of the invention.

FIG. 4 illustrates an exemplary light intensity profile of the far-field angular light intensity distribution of light emitted from a light source according to another exemplary embodiment of the invention.

### DETAILED DESCRIPTION OF THE INVENTION

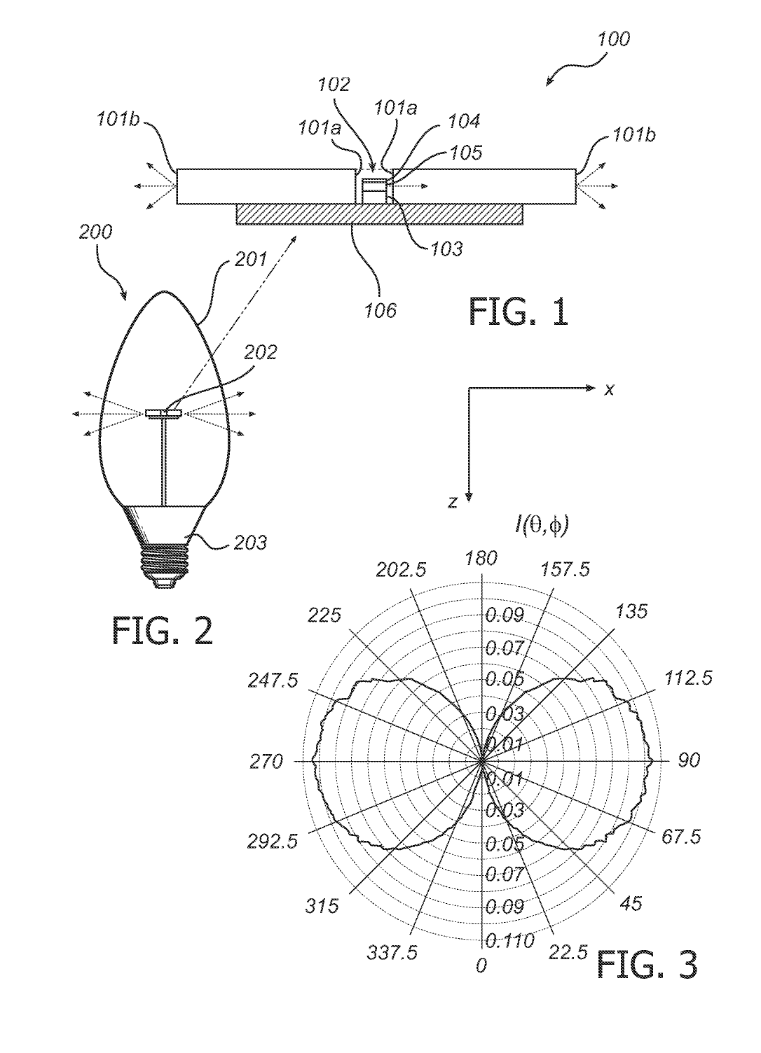

One embodiment of a light emitting device 100 according to the present invention is illustrated in FIG. 1.

The device 100 comprises at least one side emitting light source 102 comprising at least one light emitting diode 103 and a reflective layer 104 arranged spaced apart from the LED(s) 103.

Furthermore, the device comprises a light guide plate 101 which has at least one light input area 101a and at least one light output area 101b. The light guide plate 101 is arranged to extend in a direction generally transverse to the longitudinal axis of the light guide plate 101.

The light guide plate 101 comprises a depression, wherein the side emitting light source 102 is arranged; said depression forming said light input area 101a.

Light emitted by the LED(s) 103 is incident on the reflective layer 104, and, independent on the angle of incidence, it will be reflected. The reflective layer 104 is typically essentially opaque such that substantially no light will exit the device 100 through the reflective layer 104. Instead, light exiting the device 100 must do so at the opening between the LED(s) 103 and the reflective layer 104; i.e. in a direction generally transverse to the longitudinal axis of the LED(s) 103.

The reflective layer 104 is arranged such that at least a portion of light incident thereon is reflected.

The reflective layer is not limited to a specific material, but any material may be used, e.g. a metal such as Ag or Al.

Furthermore, the reflective layer 104 may comprise scattering features giving rise to an angular redistribution of light in the device 100, which increases the light extraction. Such scattering features may e.g. be particles of TiO₂, ZrO₂ or a porous polymer.

The layer 104 may also comprise facets to enhance the sparkling effect of the device.

The side emitting light source 100 is arranged in a depression in the light guide plate 101, and this depression forms the light input area 101a

As used herein, the term “light input area” means the region or surface of the light guide plate where light emitted by the LED(s) is received by the light guide.

Hence, light emitted from the light source 102 in a generally transverse direction is received by the light input area 101a of the light guide plate 101, and then propagates within the plate 101 without any substantial loss of light. There is generally no need to collimate the light before it enters the light guide. In general, light guides operate on the principle of total internal reflection (TIR), whereby light travelling through the light guide is reflected at the surfaces of the light guide based on differences in the indices of refraction of the material of the light guide and the material immediately surrounding the light guide, e.g. air, cladding, etc. Only when light encounters a surface with an angle sufficiently close to the normal, light may exit the light guide.

In the present invention, the light will exit the light guide plate 101 through the at least one light output area 101b (illustrated by the arrows in FIG. 1).

As used herein, the term “light output area” means the region or surface of the light guide plate where light is extracted from the light guide plate.

Typically the light guide plate 101 comprises an optically transparent or translucent material, such as glass or polymers, e.g. poly(methyl methacrylate) or polycarbonate.

The term “optically transparent” means that the light guide absorbs none or only minor amounts of light of the desired wavelengths passing through the light guide. Transparent materials can be seen through, i.e. they allow clear images to pass.

The term “optically translucent” refers to materials which allow light to pass through them only diffusely, i.e. the material blurs the image.

And at least one wavelength converting material 105 arranged between the LED(s) 103 and the reflective layer 104.

Light exits the light output area 101b with a wide intensity distribution which is almost constant for all viewing angles. The intensity distribution around the device 100 is substantially similar to the light intensity distribution around an incandescent light source.

Thus, the device of the invention is suitably arranged for retrofitting into a luminaire employing an incandescent light source.

As used herein, the term “retrofitting” means fitting into a light fixture normally used for incandescent light sources, such as a filamented light bulb, a halogen lamp, etc. In other words, by retrofitting the light emitting device according to the present invention into a luminaire normally employing an incandescent light source it is meant replacing the incandescent light source in the luminaire with the light emitting device according to the present invention.

In embodiments of the invention, the light source 102 further comprises at least one wavelength converting material 105 arranged between the light emitting diode(s) 103 and the reflective layer 104.

As used herein, the term “wavelength converting material” refers to a material that absorbs light of a first wavelength resulting in the emission of light of a second, longer wavelength. Upon absorption of light, electrons in the material become excited to a higher energy level. Upon relaxation back from the higher energy levels, the excess energy is released from the material in form of light having a longer wavelength than of that absorbed. Hence, the term relates to both fluorescent and phosphorescent wavelength conversion.

Any type of wavelength converting material may be used in the present device, e.g. phosphor particles such as YAG:Ce.

The use of a wavelength converting material 105 in the light source 102 allows for the color of the light output to be tailored to the need of the user, without increasing the size of the device or adding external elements to the device. This may also be regarded as decorative in a professional or home setting.

In addition, the wavelength converting material 105 may exhibit a scattering effect on the light, thereby redistributing the light and increasing the light output from the lateral edges of the light source 102.

The term “arranged between the emitting diode(s) and the reflective layer” means that the wavelength converting material 105 is sandwiched between the LED(s) 103 and the reflective layer 104. However, it may also mean that the LED(s) 103 and the reflective layer 104 could delimit a wave guiding region (not shown) for light emitted by the at least one light emitting diode, wherein the wavelength converting material 105 may be arranged at the lateral edges of such a wave guiding region.

In embodiments, the light guide plate 101 is circular. This allows for light to be emitted substantially uniformly into a full sphere (solid angle 4π sr).

The use of a circular light guide plate also allows the intensity distribution of light to be shaped such that it looks like a conventional incandescent filament.

Thus, the device 100 of the present invention is advantageously used for replacing an incandescent light source or for fitting into a light fixture normally used for incandescent light sources, such as a filamented light bulb, a halogen lamp, etc

In FIG. 2, a lamp 200 comprising a clear glass envelope 201 is illustrated. Inside the envelope 201, a light emitting device 202 according to the present invention is located. The light emitting device 202 is capable of emitting light having a spatial intensity distribution similar to an incandescent light source, such as a glowing filament. The lamp 200 may further comprise a base 203 onto which the light emitting device 202 is arranged or to which it is coupled. The base 203 typically comprises an electrical connector, which is arranged such that it is capable of mating with a socket connector of a lamp employing an incandescent light source, such as a filamented light bulb.

The circular light guide plate of the invention may be either flat or curved upwards or downwards. For example, the light guide plate may have a parabolic shape around an axis through the LED(s) and perpendicular to the axis of the LED(s).

Alternatively, the light guide plate may be shaped as a regular polygon; i.e. a polygon which is equiangular and equilateral. Facets are thereby formed in the light output area 101b of the light guide plate 101 which may create or enhance the sparkling effect of the device, even when “walking around the lamp”. As mentioned, the side emitting light source 102 is arranged in a depression in the light guide plate 101, and this depression forms the at least one light input area 101a.

The depression is preferably located in the center of the light guide plate 101. A smooth light intensity pattern can thereby be achieved.

The depression may exist in a various number of shapes, such as in the shape of a cylinder, square, polygon.

Depending on the desired light distribution effect, the parameters of the depression forming the light input area 101a may also be varied, e.g. the length, diameter, depth etc. Furthermore, the dimensions of the light guide plate, such as length, thickness, symmetry etc. may also be varied.

By adjusting the properties of the light guide plate 101 and the depression, a number of unique three dimensional light intensity profiles may be achieved.

The best result is achieved when the depression 101a has a shape which essentially matches that of the at least one light source 103. For example, if the light source is cylindrical, the depression preferably has the shape of a cylinder or a polygon, whereas a square shaped depression preferably accommodates a square shaped light source. An optimal light incoupling efficiency into the light guide plate 101 is thus achieved. Light is efficiently entered in the plate 101 through the light input area 101a, and the light output from the device 100 is further increased.

In embodiments of the invention, the thickness of the light guide plate 101 is tapered towards the light input area 101a.

In such embodiments, the light guide plate 101 is thinner near the light input area 101a, and thicker near the light output area 101b. This creates an extra degree of freedom to shape the light intensity profile.

The light guide plate 101 may also be slightly deformed to simulate a conventional filament of an incandescent lamp.

By varying the shape and dimensions of the depression, and light guide plate, respectively a number of light intensity profiles, and decorative lighting effects may be achieved.

FIG. 3 illustrates an exemplary light intensity profile of the far-field angular light intensity distribution I(θ, φ) projected onto the xz-plane of light leaving the light emitting device according to the invention, wherein θ is the polar angle from the z-axis and φ is the azimuthal coordinate in the xy-plane from the x-axis. The full three-dimensional intensity is a surface of revolution around the z-axis (in this exemplary case creating a torus around the z-axis).

The light intensity profile shown in FIG. 3 has been produced by modelling one embodiment of the invention using the illumination application software product LightTools® version 6.1.0. It should be understood that any other light intensity profile presented in the appended drawings, which light intensity profile is associated with a particular embodiment of the invention, has been produced in a similar manner unless otherwise specified.

The smooth and homogenous light intensity profile illustrated in FIG. 3 is suitable for the purpose of directly replacing a conventional incandescent lamp.

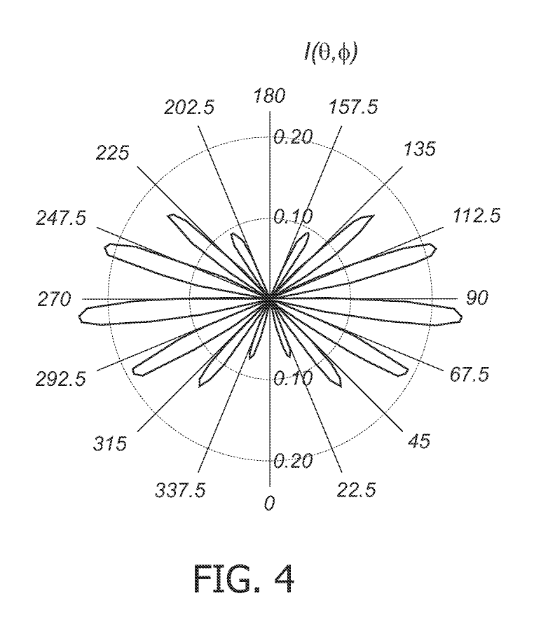

FIG. 4 illustrates a light intensity profile which is appropriate when a sparkling light effect is desirable.

Accordingly, the adjustment of the properties of the light guide plate 101 and the depression allows for a large variety of light emitting devices to be manufactured, each in general having different light intensity characteristics according to particular user needs and/or lighting environment requirements

In embodiments of the invention, the depression is a through hole in the light guide plate 101 (illustrated in FIG. 1). This allows for an increased incoupling of light into the light guide plate 101.

In alternative embodiments, the light emitting device 100 further comprises a heat sink 106 adapted to transport heat away from the light source 102. Thus, the light emitting device 100 of the present invention may be kept relatively cool to avoid burns to a user caused by contact. Furthermore, the lifetime of the light source 102 can be increased due to lessened thermal stress and/or strain in the light source components.

In embodiments, the light output area 101b comprises microstructures. Hence, light extracted from the light guide is subject to scattering upon exiting the light output area 101b of the device 100.

The invention is not limited to a specific type of microstructures, but any type of microstructures may be used to increase the scattering of the output light, e.g holographic structures.

These structures may further enhance the sparkling effect of the light emitting device, which may be regarded as highly decorative.

Furthermore, the light guide plate 101 may comprise notches in order to tune the required intensity profile. Such notches may be arranged in the region of the light guide extending from the light input area to the light output area.

In alternative embodiments, the device further comprises a reflective layer (not shown) onto which the light guide plate 101 is arranged; i.e. a reflective layer may be sandwiched between the heat sink 106 and the light guide plate 101. Such a reflective layer will reflect light emitted in a downward direction and prevent loss of light, thereby increasing the light extraction from the device 100.

Furthermore, the use of an additional reflective layer, which is preferably specularly reflective, avoids optical contact between the heat sink and the light guide, which may cause light loss by absorption.

In embodiments of the invention, multiple light sources 102 may be arranged in separate depressions of the light guide plate 101. A dynamic and continuous sparkling effect can then be achieved. Multiple LEDs with different colors may also be used, which may increase the decorative lighting effect even further.

The present invention also relates to a luminaire comprising a light emitting device 100 as described above.

Further, the present invention relates to the use of a light emitting device as well as a process for the manufacture thereof.

The invention has mainly been described above with reference to a few embodiments. However, as is readily appreciated by a person skilled in the art, other embodiments than the ones disclosed above are equally possible within the scope of the invention, as defined by the appended claims. For example, the present invention is not limited to a specific number of light sources or light emitting diodes. Neither is it limited to a specific type of light emitting diode, wavelength converting material or reflecting material, but any such material or combination of materials may be used.

In conclusion, the present invention relates to a light emitting device which may used for replacing an incandescent light source or for fitting into a light fixture normally used for incandescent light sources, which device may also be arranged to create various decorative light sparkling effects. The light source comprises a side emitting light source and a light guide having at least one light input area and at least one light output area. The light source is arranged in a depression of the light guide plate, which depression forms the at least one light input area. The light emitting device of this invention is capable of emitting light substantially uniformly into a full sphere (solid angle 4π sr), and a very compact design is achieved. The device of the present invention allows for a wide intensity distribution of light to be achieved, and to match the light intensity distribution around an incandescent light source.

1. A light emitting device comprising:
at least one side emitting light source comprising at least one light emitting diode and a reflective layer arranged spaced apart from said light emitting diode(s); and
a light guide plate having at least one light input area and at least one light output area; said light guide plate extending in a direction generally transverse to the longitudinal axis of the light guide plate;
said light guide plate comprising a depression, wherein said side emitting light source is arranged; said depression forming said light input area.

2. A light emitting device according to claim 1, arranged for retrofitting into a luminaire employing an incandescent light source

3. A light emitting device according to claim 1, wherein said light source further comprises at least one wavelength converting material arranged between said light emitting diode(s) and said reflective layer.

4. A light emitting device according to claim 1, wherein said light guide plate is circular.

5. A light emitting device according to claim 1, wherein said depression is in the center of said light guide plate.

6. A light emitting device according to claim 1, wherein said depression has a shape which essentially matches that of said at least one light source.

7. A light emitting device according to claim 1, wherein the thickness of said light guide plate is tapered towards said light input area.

8. A light emitting device according to claim 1, wherein said depression is a through hole in said light guide plate.

9. A light emitting device according to claim 1, further comprising a heat sink arranged to transport heat away form said light source.

10. A light emitting device according to claim 1, wherein said light output area comprises microstructures.

11. A lamp comprising a light emitting device according to claim 1.

12. A lamp according to claim 11, further comprising a glass envelope and a base with an electrical connector arranged for retrofitting an incandescent light source.

13. A luminaire comprising a light emitting device or a lamp according to claim 1.
